(19) United States
(12) Patent Application Publication
(10) Pub. No.: US 2025/0035235 A1
(43) Pub. Date: Jan. 30, 2025

(54) GARDEN HOSE SUPPORT

(71) Applicant: Derek Goodin, Benbrook, TX (US)

(72) Inventor: Derek Goodin, Benbrook, TX (US)

(21) Appl. No.: 18/226,445

(22) Filed: Jul. 26, 2023

(51) Int. Cl. F16L 3/02

(52) U.S. Cl. CPC F16L 3/02

(57) ABSTRACT

A support apparatus for supporting a hose above a ground surface includes a stake with a top end and a bottom end. The bottom end is pointed such that the bottom end is configured for penetrating the ground surface. A holder is coupled to the top end of the stake and is shaped such that the holder is configured for holding a hose. A plurality of protrusions is coupled to the stake and is distributed along a perimeter surface of the stake away from the holder. The plurality of protrusions is configured for indicating a height of the hose above the ground surface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to hose support apparatuses and more particularly pertains to a new hose support apparatus for supporting a hose above a ground surface.

### (2) Description of Related Art Including Information Disclosed Under 37 CFR 1.97 and 1.98.

The prior art discloses several support apparatuses for supporting a hose above a ground surface to protect grass or other plants on the ground and to prevent the hose from catching on objects when the hose is moved such that the objects or the hose are damaged. However, the apparatuses of the prior art do not include indicating members arranged along a stake to indicate a height above the ground at which the hose is held.

### BRIEF SUMMARY OF THE INVENTION

An embodiment of the disclosure meets the needs presented above by generally comprising a stake with a top end and a bottom end. The bottom end is pointed such that the bottom end is configured for penetrating a ground surface. A holder is coupled to the top end of the stake and is shaped such that the holder is configured for holding a hose. A plurality of protrusions is coupled to the stake and is distributed along a perimeter surface of the stake away from the holder. The plurality of protrusions is configured for indicating a height of the hose above the ground surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a support apparatus according to an embodiment of the disclosure.

FIG. 2 is a front view of an embodiment of the disclosure.

FIG. 3 is a side view of an embodiment of the disclosure.

FIG. 4 is a top view of an embodiment of the disclosure.

FIG. 5 is a bottom perspective view of an embodiment of the disclosure.

FIG. 6 is an in-use view of an embodiment of the disclosure.

### DETAILED DESCRIPTION OF THE INVENTION

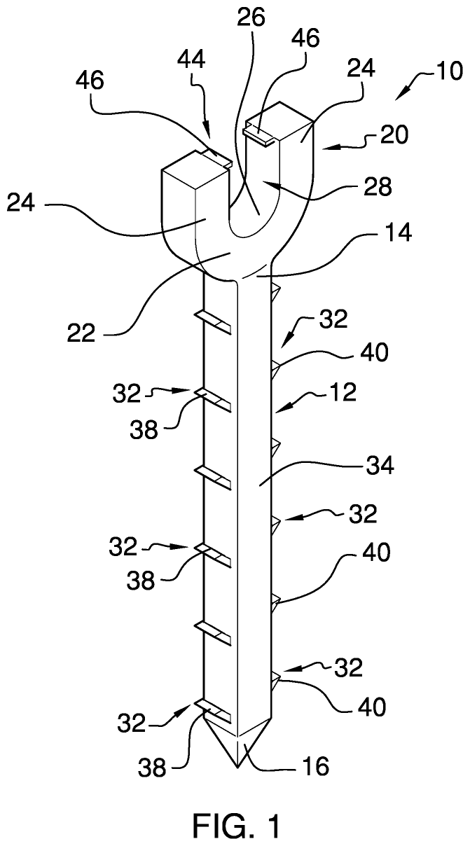

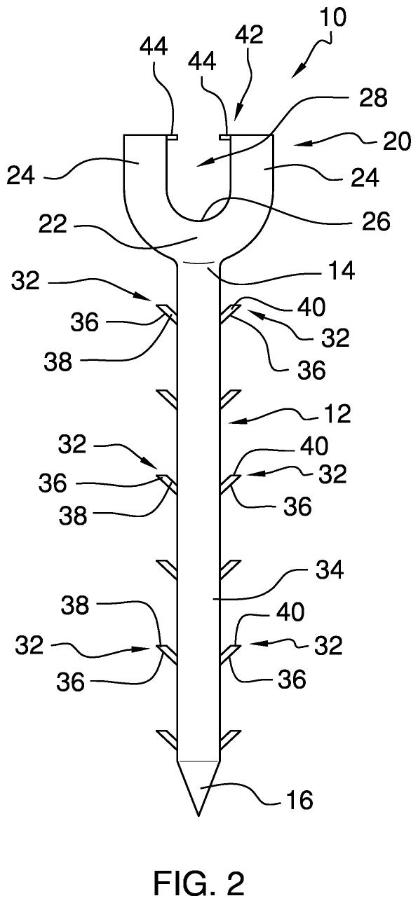

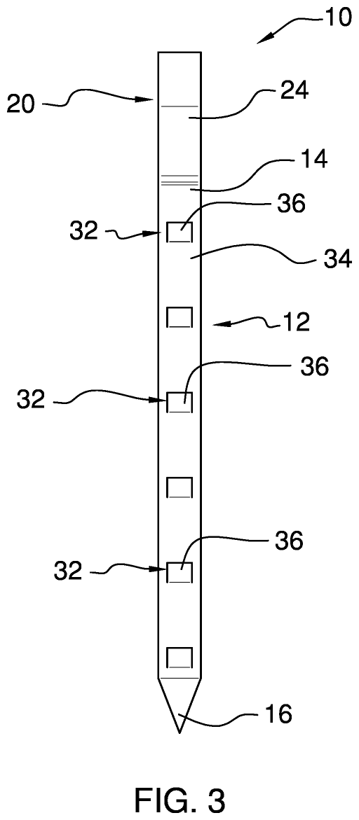

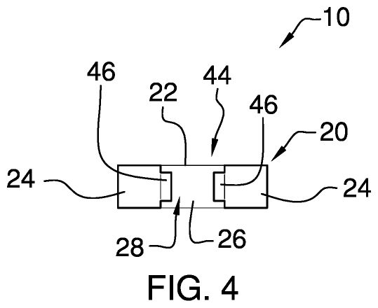

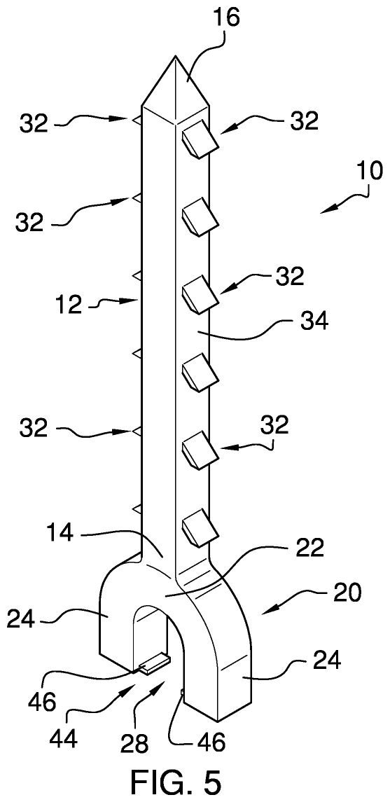

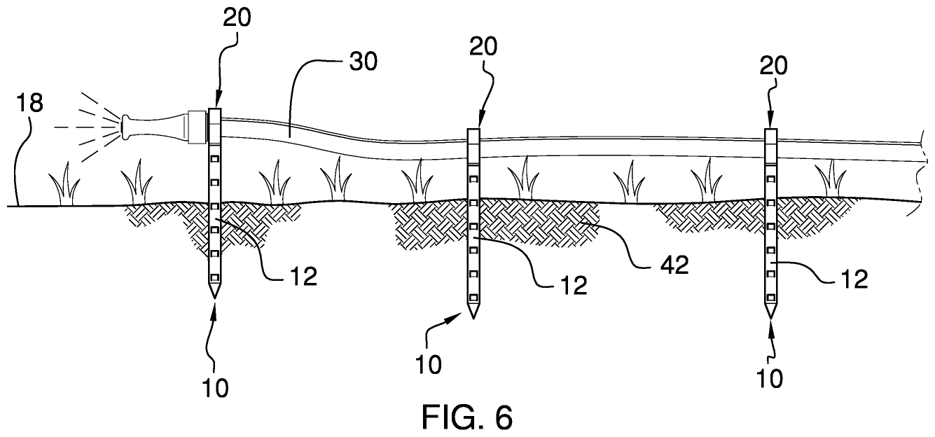

With reference now to the drawings, and in particular to FIGS. 1 through 6 thereof, a new hose support apparatus embodying the principles and concepts of an embodiment of the disclosure and generally designated by the reference numeral 10 will be described.

As best illustrated in FIGS. 1 through 6, the support apparatus 10 generally comprises a stake 12 with a top end 14 and a bottom end 16. The bottom end 16 is pointed such that the bottom end 16 is configured for penetrating a ground surface 18. A holder 20 is coupled to the top end 14 of the stake 12 and is shaped such that the holder 20 is configured for holding a hose 30. The holder 20 comprises a cross member 22 and a pair of arms 24. The cross member 22 is coupled to and extends between the pair of arms 24, and each arm 24 of the pair of arms 24 extends upwardly from the cross member 22. The holder 20 forms a groove 28 bounded by the cross member 22 and the pair of arms 24. A top surface 26 of the cross member 22 is configured for supporting the hose 30 in the groove 28 between the pair of arms 24. In other embodiments, the holder 20 may comprise a clamp to secure the hose 30 or may have an aperture extending therethrough for receiving the hose 30.

A plurality of protrusions 32 is coupled to the stake 12 and is distributed along a perimeter surface 34 of the stake 12 away from the holder 20. The plurality of protrusions 32 is configured for indicating a height of the hose 30 above the ground surface 18. Indicia may be included on or near each protrusion 32 of the plurality of protrusions 32 to indicate the height of the hose 30 via numbers, colors, symbols, or the like. The plurality of protrusions 32 is evenly vertically spaced, and a spacing between each vertically adjacent pair of protrusions 32 of the plurality of protrusions 32 is between 0.5 inches and 1.5 inches. Each protrusion 32 of the plurality of protrusions 32 extends outwardly from the perimeter surface 34 such that each protrusion 32 is configured for engaging a soil 42 underneath the ground surface 18 to inhibit moving the stake 12 relative to the soil 42. Each protrusion 32 of the plurality of protrusions 32 is angled toward the holder 20. A lower surface 36 of each protrusion 32 of the plurality of protrusions 32 is angled toward the holder 20 such that each protrusion 32 of the plurality of protrusions 32 is configured to urge the soil 42 outwardly from the stake 12 when the bottom end 16 of the stake 12 is moved downwardly into the soil 42. The plurality of protrusions 32 includes a plurality of first protrusions 38 and a plurality of second protrusions 40. Each first protrusion 38 of the plurality of first protrusions 38 is positioned opposite an associated second protrusion 40 of the plurality of second protrusions 40 across the stake 12.

A retainer 44 is coupled to the holder 20 and at least partially obstructs an opening of the groove 28 such that the retainer 44 is configured to retain the hose 30 in the groove 28. The retainer 44 comprises a pair of tabs 46, each of which is coupled to an associated arm 24 of the pair of arms 24 of the holder 20 and extends inwardly with respect to the groove 28.

In use, the bottom end 16 of the stake 12 is driven into the ground surface 18 at a selected height indicated by the plurality of protrusions 32. The hose 30 is positioned in the holder 20 so that the hose 30 is elevated above the ground surface 18. Several support apparatuses 10 may be employed for use with the hose 30 to keep the hose 30 elevated above the ground surface 18 across a length of the ground surface 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A support apparatus for supporting a hose above a ground surface, the apparatus comprising:
a stake having a top end and a bottom end, the bottom end being pointed such that the bottom end is configured for penetrating the ground surface;
a holder being coupled to the top end of the stake and being shaped such that the holder is configured for holding the hose; and
a plurality of protrusions being coupled to the stake and being distributed along a perimeter surface of the stake away from the holder, the plurality of protrusions being configured for indicating a height of the hose above the ground surface.

2. The apparatus of claim 1, wherein the holder comprises a cross member and a pair of arms, the cross member being coupled to and extending between the pair of arms, each arm of the pair of arms extending upwardly from the cross member, the holder forming a groove bounded by the cross member and the pair of arms, a top surface of the cross member being configured for supporting the hose in the groove between the pair of arms.

3. The apparatus of claim 1, wherein the protrusions of the plurality of protrusions are evenly vertically spaced.

4. The apparatus of claim 1, wherein a spacing between each vertically adjacent pair of protrusions of the plurality of protrusions being between 0.5 inches and 1.5 inches.

5. The apparatus of claim 1, wherein each protrusion of the plurality of protrusions extends outwardly from the perimeter surface such that each protrusion is configured for engaging a soil underneath the ground surface to inhibit moving the stake relative to the soil.

6. The apparatus of claim 5, wherein each protrusion of the plurality of protrusions is angled toward the holder.

7. The apparatus of claim 5, wherein a lower surface of each protrusion of the plurality of protrusions is angled toward the holder such that each protrusion of the plurality of protrusions is configured to urge the soil outwardly from the stake when the bottom end of the stake is moved downwardly into the soil.

8. The apparatus of claim 1, wherein the plurality of protrusions includes a plurality of first protrusions and a plurality of second protrusions, each first protrusion of the plurality of first protrusions being positioned opposite an associated second protrusion of the plurality of second protrusions across the stake.

9. The apparatus of claim 2, further comprising a retainer being coupled to the holder, the retainer at least partially obstructing an opening of the groove such that the retainer is configured to retain the hose in the groove.

10. The apparatus of claim 9, wherein the retainer comprises a pair of tabs, each tab of the pair of tabs being coupled to an associated arm of the pair of arms of the holder and extending inwardly with respect to the groove.

11. A support apparatus for supporting a hose above a ground surface, the apparatus comprising:
a stake having a top end and a bottom end, the bottom end being pointed such that the bottom end is configured for penetrating the ground surface;
a holder being coupled to the top end of the stake and being shaped such that the holder is configured for holding the hose, the holder comprising a cross member and a pair of arms, the cross member being coupled to and extending between the pair of arms, each arm of the pair of arms extending upwardly from the cross member, the holder forming a groove bounded by the cross member and the pair of arms, a top surface of the cross member being configured for supporting the hose in the groove between the pair of arms;
a plurality of protrusions being coupled to the stake and being distributed along a perimeter surface of the stake away from the holder, the plurality of protrusions being configured for indicating a height of the hose above the ground surface, the plurality of protrusions being evenly vertically spaced, a spacing between each vertically adjacent pair of protrusions of the plurality of protrusions being between 0.5 inches and 1.5 inches, each protrusion of the plurality of protrusions extending outwardly from the perimeter surface such that each protrusion is configured for engaging a soil underneath the ground surface to inhibit moving the stake relative to the soil, each protrusion of the plurality of protrusions being angled toward the holder, a lower surface of each protrusion of the plurality of protrusions being angled toward the holder such that each protrusion of the plurality of protrusions is configured to urge the soil outwardly from the stake when the bottom end of the stake is moved downwardly into the soil, the plurality of protrusions including a plurality of first protrusions and a plurality of second protrusions, each first protrusion of the plurality of first protrusions being positioned opposite an associated second protrusion of the plurality of second protrusions across the stake; and
a retainer being coupled to the holder, the retainer at least partially obstructing an opening of the groove such that the retainer is configured to retain the hose in the groove, the retainer comprising a pair of tabs, each tab of the pair of tabs being coupled to an associated arm of the pair of arms of the holder and extending inwardly with respect to the groove.
